(19) United States
(12) Patent Application Publication
(10) Pub. No.: US 2010/0306161 A1
(43) Pub. Date: Dec. 2, 2010

(54) CLICK THROUGH RATE PREDICTION USING A PROBABILISTIC LATENT VARIABLE MODEL

(75) Inventors: Ye Chen, Sunnyvale, CA (US); Dmitry Pavlov, San Jose, CA (US); John Canny, Berkeley, CA (US); Eren Manavoglu, Menlo Park, CA (US)

Correspondence Address: Mauriel Kapouytian & Treffert LLP, 151 1st Avenue, #23, New York, NY, 10003, US

(73) Assignee: Yahoo! Inc., Sunnyvale, CA (US)

(21) Appl. No.: 12/474,668

(22) Filed: May 29, 2009

(51) Int. Cl. G06N 7/02; G06Q 30/00; G06N 5/02; G06Q 10/00; G06F 17/30; G06F 15/18

(52) U.S. Cl. 706/52; 705/14.41; 705/14.52; 705/14.54; 706/46; 706/12

(57) ABSTRACT

Methods and systems are provided for predicting click through rate in connection with a particular user, keyword-based query, and advertisement using a probabilistic latent variable model. Click through rate may be predicted based on historical sponsored search activity information. Predicted click through rate may be used as a factor in determining advertisement rank.

### BACKGROUND

Sponsored search, including providing sponsored advertisements in connection with user keyword queries, is an important source of revenue for many Internet-based companies. Click through rate (CTR), including the rate at which a user or users click on or otherwise select sponsored search advertisements, is an important parameter in sponsored search. Furthermore, accurate predictions relating to CTR, such as for a particular user and a particular advertisement, is important for numerous purposes and applications including many relating to sponsored search. This includes CTR predictions relating to a particular user about whom limited historical information, including click information, may be available.

CTR prediction can be an important factor in determining, among other things, sponsored search advertisement ranking. Improving or optimizing sponsored search advertisement ranking, in turn, is important in improving or maximizing revenue obtained by, for example, an Internet-based company as a result of hosting or facilitating the sponsored search function or application. CTR prediction can be useful in many other ways and contexts as well.

There is a need for methods and systems for predicting CTR, and for sponsored search advertisement ranking.

### SUMMARY

In some embodiments, the invention provides methods and systems for predicting click through rate in connection with a particular user, keyword-based query, and advertisement using a probabilistic latent variable model (PLVM). CTR may be predicted based on historical sponsored search activity information. Predicted CTR may be used as a factor in determining advertisement rank.

Use of a PLVM according to embodiments of the invention provides an elegant, efficient, scalable solution for predicting CTR. Use of a PLVM allows simplification of an initial many-dimensional matrix of user, query, and advertisement information into an approximated factorization of two lower-dimensional matrices, each having one or more topical latent, or unobserved, variables as one or more dimensions. Through machine learning techniques using historical sponsored search activity information as training set data, the two matrices can be approximated. Topical information, which may be in a sense hidden or implicit in the initial matrix, becomes an explicit dimension in the two matrices. The two matrices can be an advertisement-topic matrix and a user-topic matrix, as further explained below. The advertisement-topic matrix may be kept fixed, while the user-topic matrix may be updated as new sponsored search activity information becomes available. Furthermore, use of a PLVM allows personalization, in that information regarding a particular user, while incomplete, can nonetheless be used to affect and increase the accuracy of the predicted CTR. At run-time, matrix multiplication can be performed with regard to a particular user, query, and advertisement, yielding a score which correlates to a predicted CTR. The predicted CTR can be used as a factor in determining advertisement rank, or for other purposes. Better advertisement rank leads to better monetization and more revenue.

In one embodiment, the invention provides a method including, using one or more computers, storing a matrix of information associated with historical sponsored search activity, including user information, query information, and advertisement information associated with the sponsored search activity. The method further includes, using one or more computers, modeling the matrix utilizing a probabilistic latent variable model, in which a latent variable is topical and relates to topics with which users and advertisements can be associated based on the historical sponsored search activity. The method further includes, using one or more computers, utilizing the probabilistic latent variable model to generate and store a predicted click through rate relating to a first user, a first query and a first advertisement.

In another embodiment, the invention provides a system including one or more server computers communicatively connected to the Internet, and one or more databases connected to the one or more servers. The one or more databases are for storing a matrix of information associated with historical sponsored search activity, including user information, query information, and advertisement information associated with the sponsored search activity. The one or more server computers are for modeling the matrix utilizing a probabilistic latent variable model, in which a latent variable is topical and relates to topics with which users and advertisements can be associated based on the historical sponsored search activity. The one or more server computers are further for utilizing the probabilistic latent variable model to generate and store a predicted click through rate relating to a first user, a first query and a first advertisement.

In another embodiment, the invention provides a computer readable medium or media containing instructions for executing a method. The method includes storing, in one or more memories in one or more computers, a matrix of information associated with historical sponsored search activity, the information including user information, query information, and advertisement information associated with the activity. The method further includes, using one or more memories of one or more computers, modeling the matrix utilizing a probabilistic latent variable model, in which a latent variable of the model is topical and relates to topics with which users and advertisements can be associated based on the historical sponsored search activity. The method further includes approximating the matrix by factorization into a first matrix and a second matrix. The first matrix includes information associating advertisements with topics, and the first matrix is kept fixed. The second matrix includes information associating users with topics, and the second matrix is repeatedly updated based on newly obtained sponsored search activity information. The method further includes, using one or more processors of one or more computers, performing matrix multiplication of the first matrix and the second matrix with respect to a first user, a first query and a first advertisement to obtain a first score. The method further includes, using one or more processors of one or more computers, generating and storing a predicted click through rate relating to the first user, the first query and the first advertisement by correlating the first score with an associated click through rate.

### BRIEF DESCRIPTION OF THE DRAWINGS

FIG. 1 is a distributed computer system according to one embodiment of the invention;

FIG. 2 is a flow diagram of a method according to one embodiment of the invention;

FIG. 3 is a flow diagram of a method according to one embodiment of the invention; and

FIG. 4 is a conceptual block diagram according to one embodiment of the invention.

While the invention is described with reference to the above drawings, the drawings are intended to be illustrative, and the invention contemplates other embodiments within the spirit of the invention.

### DETAILED DESCRIPTION

In some embodiments, the present invention uses a probabilistic latent variable model (PLVM) in predicting sponsored search click through rate (CTR). The prediction can be in relation to a particular user, the user's query, and a particular advertisement. The model can utilize historical sponsored search activity information including click (or other selection) behavior and including information regarding multiple users, queries, and advertisements. The predicted CTR can then be used in a variety of ways. In some embodiments, the predicted CTR is used as at least a factor in determining sponsored search advertisement ranking.

While the present application fully and sufficiently describes the invention, it is noted that the invention is to be the subject of a technical report, “GaP Model and A Variant for Sponsored Search”, by Ye Chen, Dmitry Pavlov, John Canny, and Eren Manavoglu.

PLVMs generally can include modeling a many-dimensional initial matrix as an approximate factorization, or approximate decomposition, into two fewer-dimensional matrices. The latent, or unobserved, variable or variables may be a dimension or dimensions in each of the two matrices. The latent variable or variables may not be a dimension or dimensions of the initial matrix, but the initial matrix may contain information which may implicitly, or by inference or other manipulation or determination, allow information to be obtained regarding the latent variable or variables.

In some embodiments, the present invention utilizes an initial matrix with historical sponsored search activity information including user information, query information, and advertisement information. This information can include features, or characteristics, of advertisements and of users. Using machine learning techniques, for example, information regarding user and advertisement association, and strength of association, with particular topics may be estimated. Although the invention is described with respect to topics and a topical latent variable, other types of latent variables are contemplated. According to a PLVM method, the initial matrix may be approximately factorized into two smaller-dimensional matrices.

In some embodiments, the two smaller dimensional matrices can be an ad-topic matrix and a user-topic matrix. The ad-topic matrix can allow determination or estimation of the strength of association between a particular advertisement and a particular topic. The user-topic matrix can allow determination or estimation of the strength of association between a particular user and a particular topic. In some embodiments, the ad-topic matrix may be kept fixed, while the user-topic matrix may be repeatedly updated as new sponsored search activity information becomes available.

In some embodiments, the initial matrix contains information from which topic information, in connection with users and advertisements, can be inferred, estimated, or determined, and then used in constructing the two smaller matrices. As such, topic information may be implicit or, in a sense, hidden, in the initial matrix.

In some embodiments, the initial matrix contains a user dimension, and includes feature information for each user. However, for a particular user, incomplete feature information may be available. In spite of this, available information can be used to approximate the user-topic, such as by using machine learning techniques in which the available information is used as training set information. As such, topic information can be estimated and built into the user-topic matrix. As such, embodiments of the invention provide for a personalized model, in that information relating to a particular user is used in a CTR prediction relating to that user, as opposed, for example, to only using aggregated information for a group of users in a generalized way.

In some embodiments, at run-time, such as following user entry of a keyword-based query (or the obtaining of such information by a server computer), matrix multiplication can be performed relating to the ad-topic matrix and the user-topic matrix with respect to the particular user, query, and advertisement in order to arrive at a score, which score may be proportional or correlated to predicted CTR with regard to the user, query, and advertisement. For instance, in some embodiments, matrix multiplication may be performed by vector multiplication with respect to the appropriate columns from the ad-topic and user-topic matrices.

The predicted CTR can be used as at least a factor in advertisement ranking, or for other uses. Bettering or optimizing advertisement ranking, in turn, can lead to better sponsored search monetization generally, and better revenue for entities including an operator or other entity associated with providing the search engine, for instance.

In some embodiments, the invention uses a PLVM called a Gamma-and-Poisson model, or GaP model. The GaP model is a well-defined generative model (as opposed to a discriminative model) with good empirical regularization. Furthermore, the GaP model allows personalization, or the use of personalized or individual user click feedback to allow projections into a low-dimensional latent space, with corresponding benefits to accuracy of CTR prediction and, in some embodiments, advertisement ranking. Furthermore, the dimensionality reduction of the method yields good generalization or smoothing on new user, query, and advertisement examples. The smoothed prediction further allows the model to focus on a predicted albeit sparse feature. Finally, the low dimensionality of the factorized matrices helps make machine learning training and online prediction faster and scalable.

GaP models allow scalable implementation using an extremely efficient iterative algorithm, specifically, multiplicative recurrence, which handles data sparseness and locality issues very well. Furthermore GaP models are rich models, but preserve high efficiency through linear parameterization, and regularizes learned models with empirical priors. This allows providing of a relatively simple, elegant, data-driven solution, without need for tedious and slow feature engineering and data preprocessing.

GaP models allow direct prediction of CTR. The models also allow building personalization into sponsored search CTR prediction (as discussed above). Furthermore, the models provide a dimensionality reduction algorithm, providing excellent scalability and great practical advantages when used with Web-scale amounts of data, such as in sponsored search. Furthermore, the models provide a smoothing algorithm, yielding smoothed click predictions, addressing the data sparseness problem often present with click data. Further, the models allows taking into account the position of the advertisement impression in predicting CTR. Finally, approximated factorized matrices, as well as predicted CTR, can be used in applications other than advertisement ranking, including user clustering and segmentation, collaborative filtering, and behavioral targeting.

While the invention is described primarily with regard to sponsored search and advertising, the invention also contemplates other contexts, such as any context in which predictions relating to CTR are useful. Furthermore, while the invention is described with reference to CTR, the invention also contemplates other forms of selection, associated navigation, or activation (for example, mouse-over instead of clicking), as well as other performance parameters overall, such as other advertisement performance parameters which may relate to user navigation in connection with an advertisement. Furthermore, while described in relation to advertising and advertisements, the invention contemplates embodiments in which other items, such as content or links to content are involved instead of or in addition to advertisements or sponsored search advertisements.

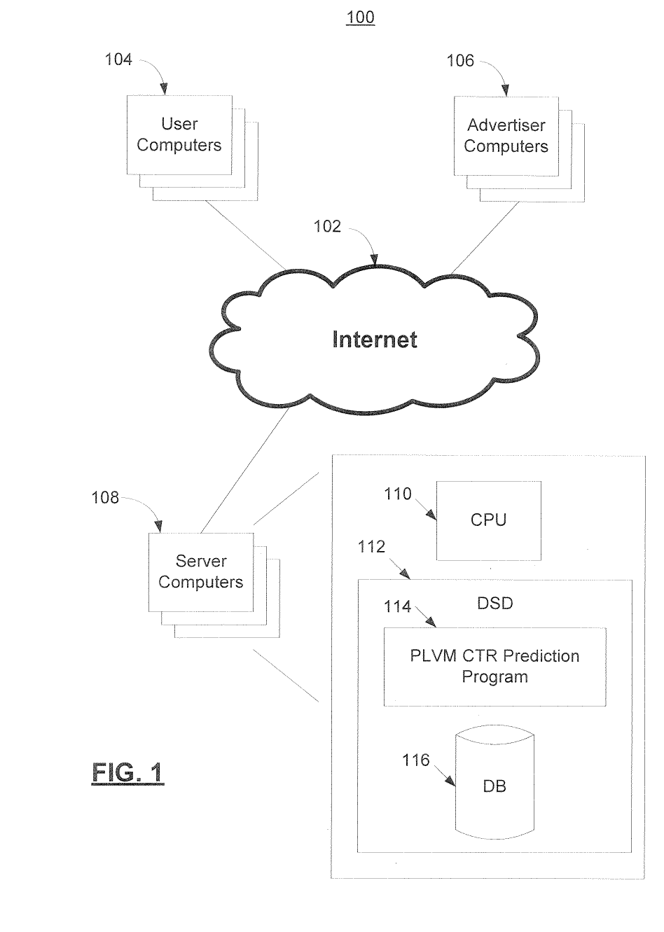

FIG. 1 is a distributed computer system 100 according to one embodiment of the invention. The system 100 includes user computers 104, advertiser computers 106 and server computers 108, all connected or connectable to the Internet 102. Although the Internet 102 is depicted, the invention contemplates other embodiments in which the Internet is not includes, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phone, PDA, etc.

Each of the one or more computers 104, 106, 108 may be distributed, and can include various hardware, software, applications, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as keyword searching and advertising in a sponsored search context.

As depicted, each of the server computers 108 includes one or more CPUs 110 and a data storage device 112. The data storage device 112 includes one or more databases 116 and a probabilistic latent variable model (PLVM) click through rate (CTR) prediction program 114. The one or more databases 116 may be connected to the one or more server computers 108, which may include being part of the one or more server computers 108.

The PLVM CTR prediction program 114 is intended to broadly include all programming, applications, software and other and tools necessary to implement or facilitate methods and systems according to embodiments of the invention, whether on one computer or distributed among multiple computers. Furthermore, PLVM, as the term is used herein, broadly includes the model including adaptations and additions in connection with the invention, and its use in and through obtaining a predicted CTR.

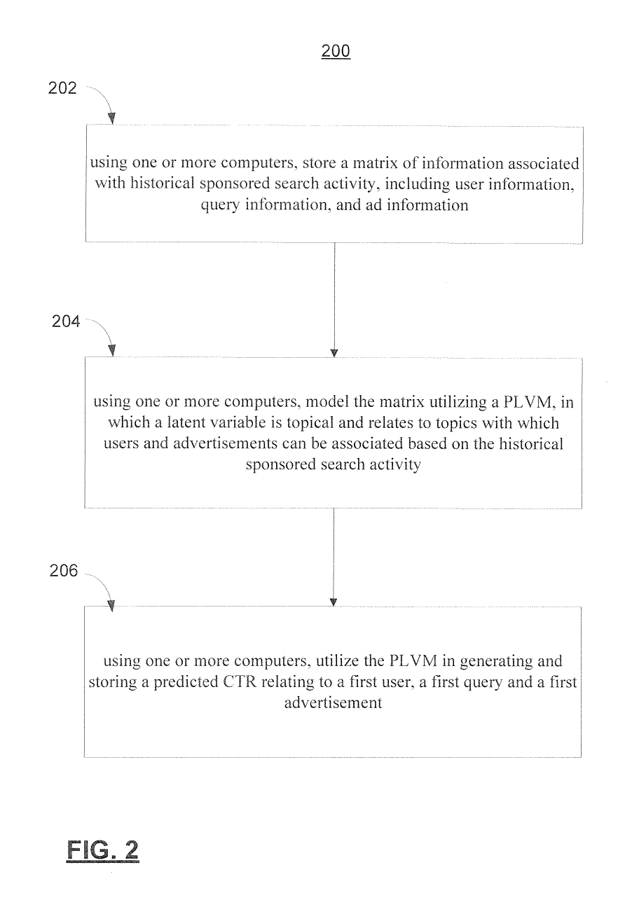

FIG. 2 is a flow diagram of a method 200 or algorithm according to one embodiment of the invention. The method 200 can be carried out or facilitated using the PLVM CTR prediction program 114.

At step 202, using one or more computers, such as server computer(s) 108, a matrix of information is stored associated with historical sponsored search activity, including user information, query information, and advertisement information. For example, the historical sponsored search activity can be stored in the database(s) 116 of the server computer(s) 108.

Next, at step 204, using one or more computers, the matrix is modeled using a PLVM in which a latent variable is topical and relates to topics with which users and advertisements can be associated based on the historical sponsored search activity.

Finally, at step 206, using one or more computers, the PLVM is used to predict CTR relating to a first user, a first query, and a first advertisement.

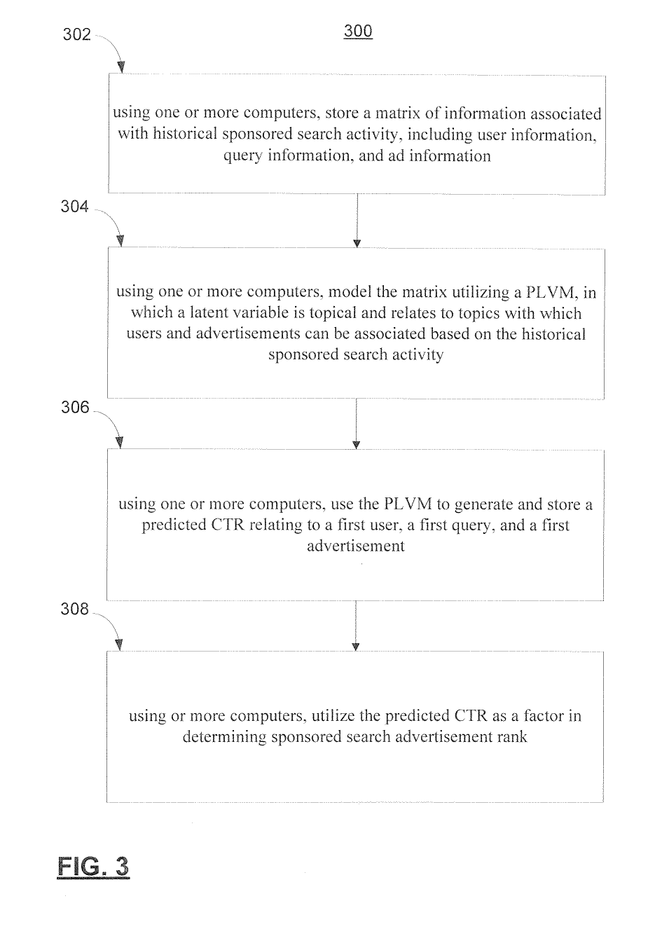

FIG. 3 is a flow diagram of a method 300 or algorithm according to one embodiment of the invention. The method 200 can be carried out or facilitated using the PLVM CTR prediction program 114.

At step 302, using one or more computers, a matrix of information is stored associated with historical sponsored search activity, including user information, query information, and advertisement information.

Next, at step 304, using one or more computers, the matrix is modeled utilizing a PLVM, in which a latent variable is topical and relates to topics with which users and advertisements can be associated based on the historical sponsored search activity.

Next, at step 306, using one or more computers, the PLVM is used to generate and store a predicted CTR relating to a first user, a first query, and a first advertisement.

Finally, at step 308, the predicted CTR is utilized as a factor in determining sponsored search advertisement rank. In other embodiments of the invention, however, the predicted CTR may be used in a variety of ways, and for a variety of other purposes.

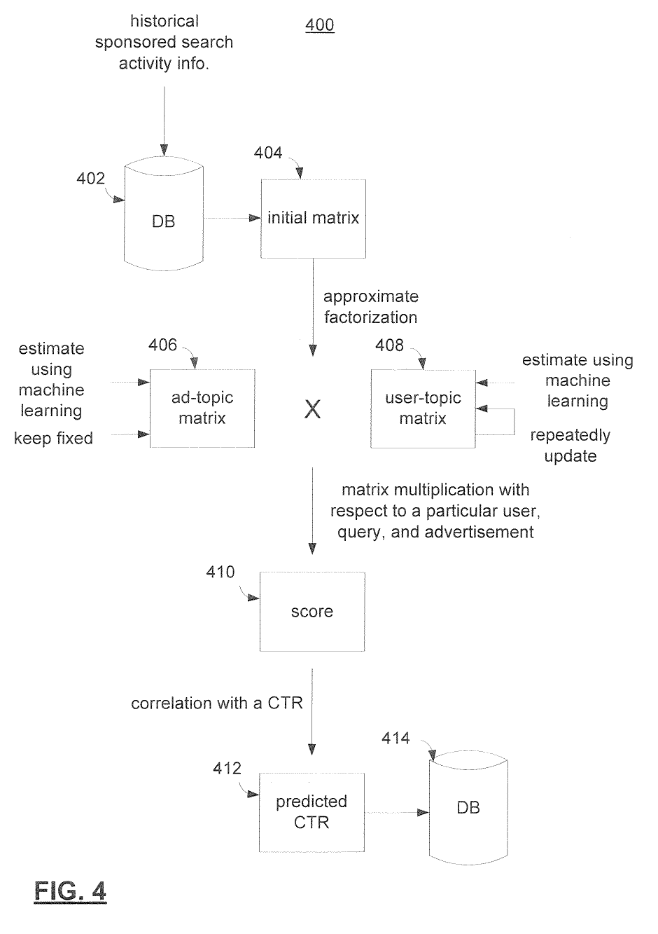

FIG. 4 is a conceptual block diagram 400 according to one embodiment of the invention.

Block 402 represents a database of stored historical sponsored search activity information, such as information relating to user keyword searches and sponsored search advertisements served in connection therewith. The database can include user information, user query information, and advertisement information, which can include features of users and advertisements, or information or information from which features can be inferred or determined.

Block 404 represents an initial matrix of information formed using information stored in the database and including information relating to users, queries, and advertisements.

Blocks 406 and 408 represent an approximated factorization of the initial matrix in to two matrices, an ad-topic matrix and a user-topic matrix, in accordance with a PLVM technique. In some embodiments of the invention, the ad-topic and user-topic matrices are formed using machine learning techniques, in which training sets may include historical sponsored search activity information. In some embodiments, the ad-topic matrix is kept fixed, while the user-topic matrix is repeatedly updated as new sponsored search activity information becomes available.

Block 410 represents a score determined for a particular user, query, and advertisement. More specifically, the score results from matrix multiplication with respect to the associated elements of the two matrices. In some embodiments, the score correlates with predicted CTR, such that the score multiplied by a constant will result in predicted CTR. The invention also contemplates embodiments where CTR results immediately from the matrix multiplication, and where the score can or must be manipulated in a more complex way in order to arrive at the predicted CTR.

Block 412 represents correlation of the score with a predicted CTR, and block 414 represents generation and storage of the predicted CTR in a database.

The foregoing description is intended to be illustrative, and other embodiments are contemplated within the spirit of the invention.

What is claimed is:

1. A method comprising:
using one or more computers, storing a matrix of information associated with historical sponsored search activity, the information including user information, query information, and advertisement information associated with the historical sponsored search activity;
using one or more computers, modeling the matrix utilizing a probabilistic latent variable model, wherein a latent variable of the model is topical and relates to topics with which users and advertisements can be associated based on the historical sponsored search activity; and
using one or more computers, utilizing the model to generate and store a predicted click through rate relating to a first user, a first query and a first advertisement.

2. The method of claim 1, wherein modeling the matrix comprises incorporating personalization with respect to a user, such that the predicted click through rate can be affected by features of the user known from historical sponsored search activity and incorporated into one or more matrices of the model.

3. The method of claim 1, wherein at least one matrix of the model is constructed at least in part based utilizing a machine learning technique.

4. The method of claim 1, wherein at least one matrix of the model is constructed at least in part based utilizing a machine learning technique that utilizes one or more training sets based on historical sponsored search activity.

5. The method of claim 1, wherein the model is a Gamma-and-Poisson model.

6. The method of claim 1, wherein the predicted click through rate is used as a factor in determining advertisement rank.

7. The method of claim 1, wherein modeling the matrix utilizing a probabilistic latent variable model comprises:
approximating the matrix by factorization into a first matrix and a second matrix, wherein:
the first matrix includes information associating advertisements with topics, wherein the first matrix is kept fixed; and
the second matrix includes information associating users with topics, wherein the second matrix is repeatedly updated based on newly obtained sponsored search activity information.

8. The method of claim 7, wherein utilizing the probabilistic latent variable model to generate and store a predicted click through rate relating to a first user and a first advertisement comprises:
using one or more processors of one or more computers, performing matrix multiplication relating to the first matrix and the second matrix with respect to a first user, a first query and a first advertisement to obtain a first score; and using one or more processors of one or more computers, determining a predicted click through rate relating to the user, the first query and the advertisement by correlating the first score with an associated click through rate.

9. The method of claim 8, wherein the first matrix is obtained using machine learning and using a training set including historical sponsored search activity information.

10. The method of claim 8, wherein the second matrix is obtained using machine learning and using a training set including historical sponsored search activity information.

11. A system comprising:
One or more server computers connected to the Internet, and
One or more databases connected to the one or more servers;
wherein the one or more databases are for storing a matrix of information associated with historical sponsored search activity, the information including user information, query information, and advertisement information associated with the sponsored search activity;
and wherein the one or more server computers are for:
modeling the matrix utilizing a probabilistic latent variable model, wherein a latent variable of the model is topical and relates to topics with which users and advertisements can be associated based on the historical sponsored search activity; and
utilizing the model to generate and store a predicted click through rate relating to a first user, a first query and a first advertisement.

12. The system of claim 11, wherein modeling the matrix comprises incorporating personalization with respect to a user, such that the predicted click through rate can be affected by features of the user known from historical sponsored search activity and incorporated into one or more matrices of the model.

13. The system of claim 11, wherein at least one matrix of the model is constructed at least in part based utilizing a machine learning technique.

14. The system of claim 13, wherein the first matrix is obtained using machine learning and using a training set including historical sponsored search activity information.

15. The method of claim 11, wherein the second matrix is obtained using machine learning and using a training set including historical sponsored search activity information.

16. The system of claim 11, wherein the predicted click through rate is used as a factor in determining advertisement rank.

17. The system of claim 11, wherein modeling the matrix utilizing a probabilistic latent variable model comprises:
approximating the matrix by factorization into a first matrix and a second matrix, wherein:
the first matrix includes information associating advertisements with topics, wherein the first matrix is kept fixed; and
the second matrix includes information associating users with topics, wherein the second matrix is repeatedly updated based on newly obtained sponsored search activity information.

18. The system of claim 17, wherein utilizing the probabilistic latent variable model to predict a click through rate relating to a first user and a first advertisement comprises:
using one or more processors of one or more computers, performing matrix multiplication relating to the first matrix and the second matrix with respect to a first user, a first query and a first advertisement to obtain a first score; and
using one or more processors of one or more computers, determining a predicted click through rate relating to the user, the first query and the advertisement by correlating the first score with an associated click through rate.

19. The system of claim 17, wherein the one or more servers are connected to the Internet.

20. A computer readable medium or media containing instructions for executing a method, the method comprising:
storing, in one or more memories in one or more computers, a matrix of information associated with historical sponsored search activity, the information including user information, query information, and advertisement information associated with the activity;
using one or more memories of one or more computers, modeling the matrix utilizing a probabilistic latent variable model, wherein a latent variable of the model is topical and relates to topics with which users and advertisements can be associated based on the historical sponsored search activity, comprising:
approximating the matrix by factorization into a first matrix and a second matrix, wherein:
the first matrix includes information associating advertisements with topics, wherein the first matrix is kept fixed; and
the second matrix includes information associating users with topics, wherein the second matrix is repeatedly updated based on newly obtained sponsored search activity information;
using one or more processors of one or more computers, performing matrix multiplication of the first matrix and the second matrix with respect to a first user, a first query and a first advertisement to obtain a first score; and
using one or more processors of one or more computers, generating and storing a predicted click through rate relating to the first user, the first query and the first advertisement by correlating the first score with an associated click through rate.
